(19) United States
(12) Patent Application Publication
(10) Pub. No.: US 2016/0353356 A1
(43) Pub. Date: Dec. 1, 2016

(54) APPLICATION-SPECIFIC CONGESTION CONTROL FOR DATA COMMUNICATION (ACDC) IN CONNECTED MODE

(71) Applicant: QUALCOMM Incorporated, San Diego, CA (US)

(72) Inventors: Ajith Payyappilly, San Diego, CA (US); Lenaig Genevieve Chaponniere, La Jolla, CA (US); Arvind Santhanam, San Diego, CA (US); Srinivasan Balasubramanian, San Diego, CA (US); Sivaramakrishna Veerepalli, San Diego, CA (US); Suli Zhao, San Diego, CA (US); Vitaly Drapkin, San Diego, CA (US); Kirankumar Bhoja Anchan, San Diego, CA (US)

(21) Appl. No.: 15/168,459

(22) Filed: May 31, 2016

Related U.S. Application Data
(60) Provisional application No. 62/169,439, filed on Jun. 1, 2015.

(51) Int. Cl. H04W 48/06; H04W 24/02; H04W 28/10; H04W 28/02; H04L 12/801

(52) U.S. Cl. CPC H04W 48/06; H04W 28/0215; H04L 47/14; H04W 28/0289; H04W 28/10; H04W 24/02; H04W 88/02

(57) ABSTRACT

Aspects of the disclosure are directed to congestion control in a user equipment in connected mode including upon receipt of a trigger, using a register to determine if a data packet transmission has been initiated by an application associated with the UE, wherein the UE is in a connected mode; retrieving an Application-specific Congestion control for Data Communication (ACDC) category mapped to the application associated with the UE, wherein a mapping between the ACDC category and the application is performed a priori to a transition to the connected mode; retrieving at least one access control parameter based on the ACDC category; and determining if the application is allowed to perform the data packet transmission based on the at least one access control parameter.

### CROSS-REFERENCE TO RELATED APPLICATION

This application claims priority to and the benefit of provisional patent application No. 62/169,439, filed in the United States Patent and Trademark Office on Jun. 1, 2015, the entire content of which is incorporated herein by reference.

### FIELD OF DISCLOSURE

The technology discussed below relates generally to wireless communication systems, and more particularly, to congestion control in connected mode in a wireless communication network.

### DESCRIPTION OF RELATED ART

Wireless communication systems are widely deployed to provide various telecommunication services such as telephony, video, data, messaging, and broadcasts. Many wireless communication technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). And, successors to LTE, known generically as 5G systems are being developed. It is designed to better support mobile broadband Internet access by improving spectral efficiency, lower costs, improve services, make use of new spectrum, and better integrate with other open standards. With increasing demand for mobile broadband access granting preferential access to applications that may be of higher priority, for example, emergency services, in connected mode is addressed herein.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to various aspects of the disclosure a method for congestion control in a user equipment (UE), including upon receipt of a trigger, using a register to determine if a data packet transmission has been initiated by an application associated with the UE, wherein the UE is in a connected mode; retrieving an Application-specific Congestion control for Data Communication (ACDC) category mapped to the application associated with the UE, wherein a mapping between the ACDC category and the application is performed a priori to a transition to the connected mode; retrieving at least one access control parameter based on the ACDC category; and determining if the application is allowed to perform the data packet transmission based on the at least one access control parameter. In various aspects, the method further includes holding the data packet transmission until expiration of a barring timer or based on a barring probability; applying a flow control on the data packet transmission; or dropping a data packet associated with the data packet transmission. In various examples, a transmission control protocol (TCP) congestion control/backoff procedure is used for applying the flow control. In various examples, the trigger is one of the following: a session initiation request from the application, a request to perform the data packet transmission, an initial request from the application to perform the data packet transmission or a request from the application to send a burst of data packets after an inactivity period. In various examples, the at least one access control parameter is one of the following: a barring rate, a barring time, a barring probability, a time of day, or a geolocation of the UE.

In various examples, a data packet associated with the data packet transmission is associated with the application by an identifier of the application. And, the identifier may be an auxiliary data field which associates the data packet with the application. And, in some examples, the identifier is an operating system (OS) App ID of the application. In various examples, the data packet is tagged with the identifier and the ACDC category is retrieved based on the identifier. In various examples, the identifier is based on a combination of a source IP address or a source port and a destination IP address or a destination port associated with the application. In various aspects, the method further includes maintaining a mapping between the OS App ID and a combination of a source IP address or a source port and a destination IP address or a destination port. In various aspects, the method further includes maintaining a mapping between the ACDC category and a combination of a source IP address or a source port and a destination IP address or a destination port. In various examples, the ACDC category is ranked in an order of probability of being restricted.

According to various aspects of the disclosure, an apparatus for congestion control in a user equipment (UE), including a controller configured to perform the following: a) determine, upon receipt of a trigger, if an application associated with the UE is attempting to perform a data packet transmission, wherein the UE is in a connected mode; b) retrieve an Application-specific Congestion control for Data Communication (ACDC) category mapped to the application associated with the UE, wherein a mapping between the ACDC category and the application is performed a priori to a transition to the connected mode; and c) retrieve at least one access control parameter based on the ACDC category; and a transmitter processor coupled to the controller, the transmitter processor configured to determine if the application is allowed to perform the data packet transmission based on the at least one access control parameter; and a transmitter coupled to the transmitter processor, the transmitter configured to transmit a data packet. In various examples, the transmitter is configured to transmit the data packet on a periodic basis or according to a predetermined frequency.

In various aspects, the apparatus further includes a memory coupled to the transmitter processor, the memory configured to hold the data packet prior to the data packet transmission; and the transmitter processor is further configured to hold the data packet transmission until expiration of a barring timer or based on a barring probability. In various aspects, the transmitter processor is further configured to apply a flow control on the data packet transmission or to drop the data packet associated with the data packet transmission. In various examples, the trigger is one of the following: a session initiation request from the application, a request to perform the data packet transmission, an initial request from the application to perform the data packet transmission or a request from the application to send a burst of data packets after an inactivity period. In various examples, the data packet is associated with the application by an identifier of the application. And, in various examples, the ACDC category is ranked in an order of probability of being restricted

According to various aspects of the disclosure, an apparatus for congestion control in a user equipment (UE), including means for determining, upon receipt of a trigger, if an application associated with the UE is attempting to perform a data packet transmission, wherein the UE is in a connected mode; means for retrieving an Application-specific Congestion control for Data Communication (ACDC) category mapped to the application associated with the UE, wherein a mapping between the ACDC category and the application is performed a priori to a transition to the connected mode; means for retrieving at least one access control parameter based on the ACDC category; and means for determining if the application is allowed to perform the data packet transmission based on the at least one access control parameter. In various aspects, the apparatus further includes means for performing the data packet transmission on a periodic basis or means for performing the data packet transmission according to a predetermined frequency. In various aspects, the apparatus further includes means for holding the data packet transmission until expiration of a barring timer or based on a barring probability; and means for applying a flow control on the data packet transmission or for dropping a data packet associated with the data packet transmission.

According to various aspects of the disclosure, a non-transitory computer-readable medium storing computer executable code, the computer executable code including: instructions for causing the at least one processor to determine, upon receipt of a trigger, if an application associated with the UE is attempting to perform a data packet transmission, wherein the UE is in a connected mode; instructions for causing the at least one processor to retrieve an Application-specific Congestion control for Data Communication (ACDC) category mapped to the application associated with the UE, wherein a mapping between the ACDC category and the application is performed a priori to a transition to the connected mode; instructions for causing the at least one processor to retrieve at least one access control parameter based on the ACDC category; and instructions for causing the at least one processor to determine if the application is allowed to perform the data packet transmission based on the at least one access control parameter. In various aspects, the computer executable code further includes instructions for causing the at least one processor to hold the data packet transmission until expiration of a barring timer or based on a barring probability; and instructions for causing the at least one processor to apply a flow control on the data packet transmission or to drop a data packet associated with the data packet transmission.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the present disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a hardware implementation for an apparatus employing a processing system, in accordance with aspects of the present disclosure.

FIG. 2 is a diagram illustrating an example of a network architecture, in accordance with aspects of the present disclosure.

FIG. 3 is a diagram illustrating an example of an access network, in accordance with aspects of the present disclosure.

FIG. 4 is a diagram illustrating an example of a radio protocol architecture for a user plane and a control plane, in accordance with aspects of the present disclosure

FIG. 5 is a diagram illustrating an example of a base station and a user equipment in an access network, in accordance with aspects of the present disclosure.

FIG. 6 is a flow chart illustrating a first example for congestion control in a user equipment (UE), in accordance with aspects of the present disclosure.

FIG. 7 is a flow chart illustrating a second example for congestion control in a user equipment (UE), in accordance with aspects of the present disclosure.

FIG. 8 is a flow chart illustrating a third example for congestion control in a user equipment (UE), in accordance with aspects of the present disclosure.

FIG. 9 is a flow chart illustrating a fourth example for congestion control in a user equipment (UE), in accordance with aspects of the present disclosure.

FIG. 10 is a flow chart illustrating a fifth example for congestion control in a user equipment (UE), in accordance with aspects of the present disclosure.

FIG. 11 is a flow chart illustrating a sixth example for congestion control in a user equipment (UE), in accordance with aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system. The methods and processes disclosed herein are applicable to all radio access technologies (RATs) such as, but not limited to, GSM, UMTS, LTE and future wireless systems such as 5G.

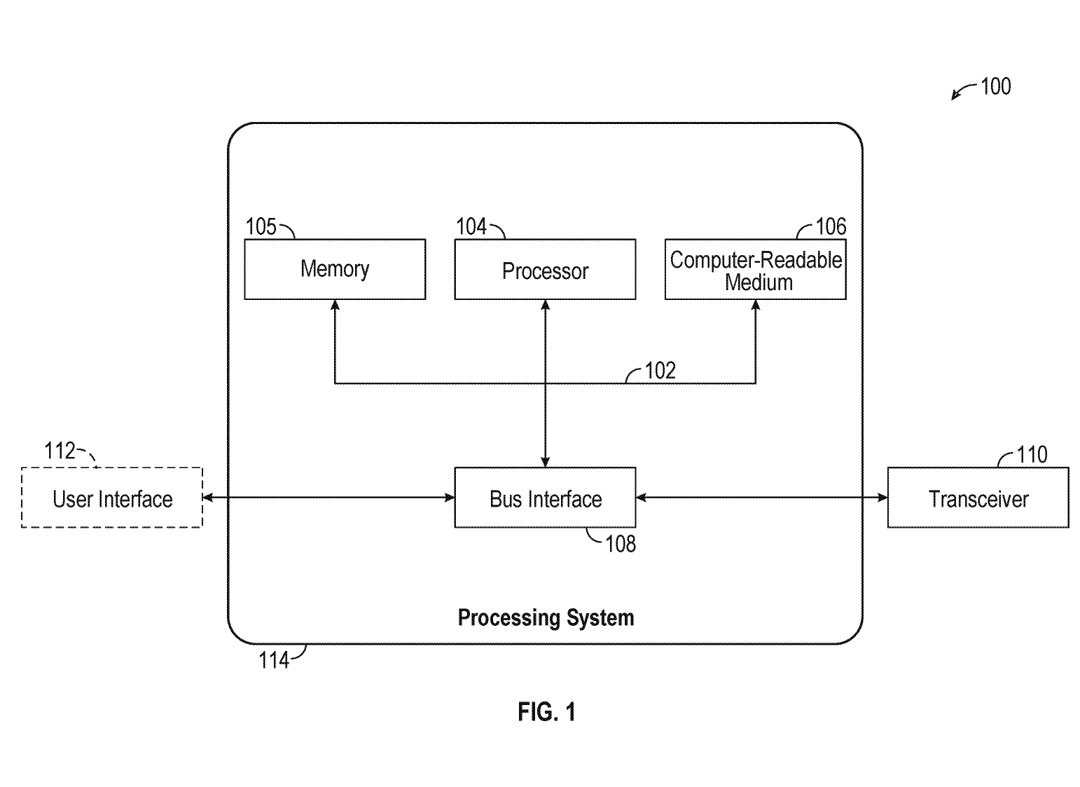

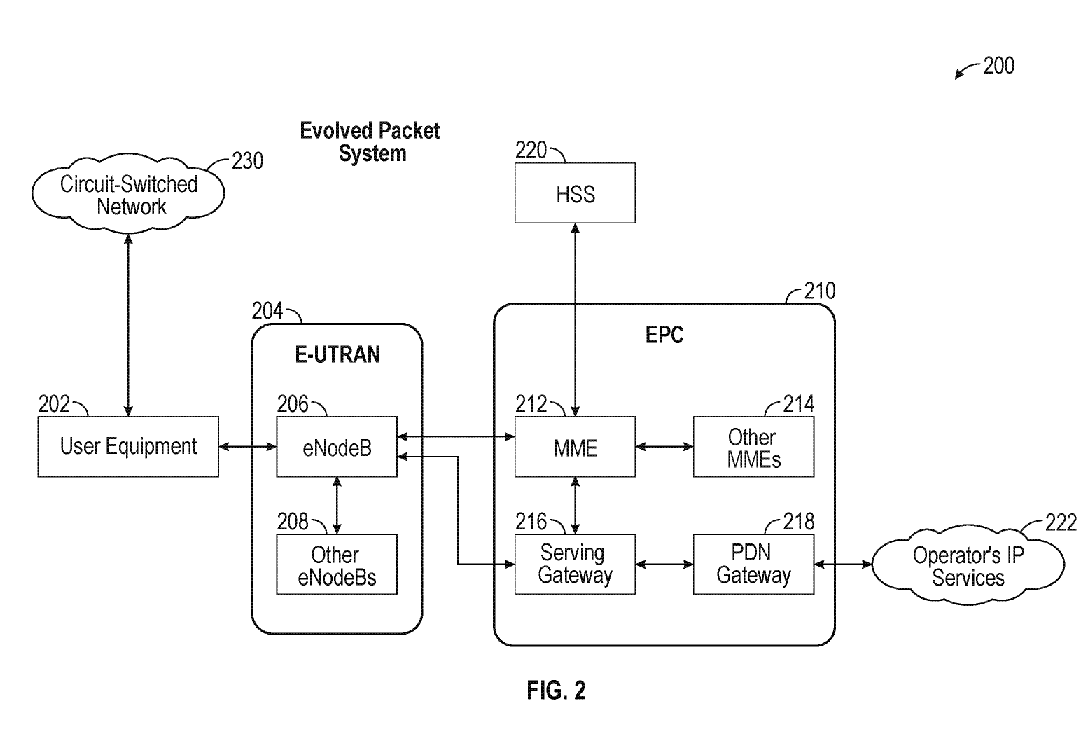

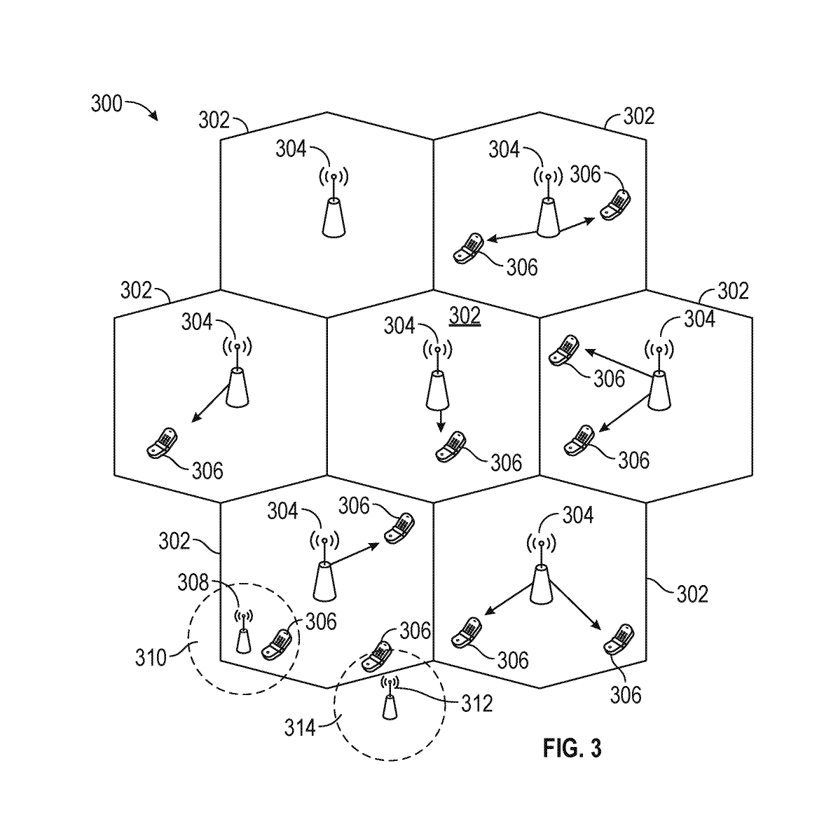

FIG. 1 is a diagram illustrating an example of a hardware implementation for an apparatus 100 employing a processing system 114. In accordance with various aspects of the disclosure, an element, or any portion of an element, or any combination of elements may be implemented with a processing system 114 that includes one or more processors 104. For example, the apparatus 100 may be a user equipment (UE) as illustrated in any one or more of FIGS. 2, 3, and/or 5. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 104, as utilized in an apparatus 100, may be used to implement any one or more of the processes described below and illustrated in FIG. X.

The processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described below for any particular apparatus. The computer-readable medium 106 may also be used for storing data that is manipulated by the processor 104 when executing software.

FIG. 2 is a diagram illustrating an example of a network architecture 200. The network architecture may be applicable to various wireless technologies. The network architecture may include a user equipment 202, a base station subsystem (BSS) 204 and a core network 210. For illustration purposes, an LTE network architecture 200 is shown herein. The LTE network architecture 200 may be referred to as an Evolved Packet System (EPS) 200. The EPS 200 may include one or more user equipment (UE) 202, a BSS 204 referred to as an Evolved UMTS Terrestrial Radio Access Network (E-UTRAN) 204, a core network 201 referred to as an Evolved Packet Core (EPC) 210, a Home Subscriber Server (HSS) 220, and an Operator's IP Services 222. The EPS may interconnect with other access networks, but for simplicity those entities/interfaces are not shown. The architecture illustrated in FIG. 2 may also be applicable to future wireless systems, such as a 5G system or beyond. The EPS may provide packet-switched services, however, as those skilled in the art will readily appreciate, the various concepts presented throughout this disclosure may be extended to networks providing circuit-switched services.

For example, in FIG. 2, the UE 202 is illustrated as being capable of utilizing a second communication link to a circuit-switched (CS) network 230. In the illustrated example, the UE communicates with the CS network 230 separately from its communication with the eNB 206. In another example, the serving eNB 206 may be capable of communicating with the CS network 230 on behalf of the UE 202. The CS network may utilize any suitable protocol or communication standard capable of circuit-switched communication, including but not limited to a UMTS network utilizing W-CDMA, TD-SCDMA or any other air interface; a 3GPP2 network such as cdma2000 1×; an IEEE 802.16 WiMAX network; or any other suitable network or combination of networks. The actual wireless communication standard and the multiple access technology employed will depend on the specific application and the overall design constraints imposed on the system.

The E-UTRAN may include the evolved Node B (eNB) 206 and other eNBs 208. The eNB 206 may provide user and control plane protocol terminations toward the UE 202. The eNB 206 may be connected to the other eNBs 208 via an X2 interface (i.e., backhaul). The eNB 206 may also be referred to by those skilled in the art as a base station, a base transceiver station, a radio base station, a radio transceiver, a transceiver function, a basic service set (BSS), an extended service set (ESS), or some other suitable terminology. The eNB 206 may provide an access point to the EPC 210 for a UE 202. Examples of UEs 202 may include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 202 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 206 may be connected by an interface (e.g., an S1 interface in LTE) to the EPC 210. The EPC 210 may include a Mobility Management Entity (MME) 212, other MMEs 214, a Serving Gateway 216, and/or a Packet Data Network (PDN) Gateway 218. In various examples, the MME 212 is a control node that processes the signaling between the UE 202 and the EPC 210. Generally, the MME 212 may provide bearer and connection management. User IP packets may be transferred through the Serving Gateway 216, which itself may be connected to the PDN Gateway 218. The PDN Gateway 218 may provide UE IP address allocation as well as other functions. The PDN Gateway 218 may be connected to the Operator's IP Services 222. The Operator's IP Services 222 may include the Internet, the Intranet, an IP Multimedia Subsystem (IMS), and/or a PS Streaming Service (PSS).

For voice communication, the UE 202 may utilize any one or more of several different schemes. For example, voice may be packetized and communicated via the EPS 200 by way of the IMS. In other examples, voice communication may utilize circuit-switched channels, by way of the CS network 230.

FIG. 3 is a diagram illustrating an example of an access network 300. The access network 300 may be applicable to various wireless technologies. However, for illustration purposes, the access network 300 is shown in an LTE network architecture. The access network 300 is shown as divided into a number of cellular regions (cells) 302. One or more lower power class eNBs 308, 312 may have cellular regions 310, 314, respectively, that overlap with one or more of the cells 302. The lower power class eNBs 308, 312 may be femto cells (e.g., home eNBs (HeNBs)), pico cells, or micro cells. A higher power class or macro eNB 304 may be assigned to a cell 302 and may be configured to provide an access point to the EPC 210 for all the UEs 306 in the cell 302. Although no centralized controller is shown in the FIG. 3 example of the access network 300, a centralized controller may be used in alternative configurations. The eNB 304 may be responsible for radio related functions including radio bearer control, admission control, mobility control, scheduling, security, and/or connectivity to the serving gateway 216 (see FIG. 2). In some examples, one or more of the cells 302 within the access network may additionally or alternatively correspond to a 3G or other suitable circuit-switched technology, as discussed above, which the UEs 306 may utilize for voice calls.

Upon power-on, or when a UE initially enters the service area of the access network 300, the UE may use information stored on its subscriber identity module (SIM) to initiate system selection. Frequently, an international mobile subscriber identity (IMSI) stored on the SIM may be used to determine the Home Public Land Mobile Network (HPLMN) code and may serve as the basis for PLMN selection. Optionally, the SIM may have an Equivalent HPLMN list, and priorities among various PLMNs may determine the PLMN selection. Using this search information, the UE may retrieve system information broadcasted from a nearby cell, and may accordingly make a PLMN selection and camp on a suitable cell. The selected PLMN may be known as the Registered PLMN (RPLMN) and may be stored on the SIM for future system selections.

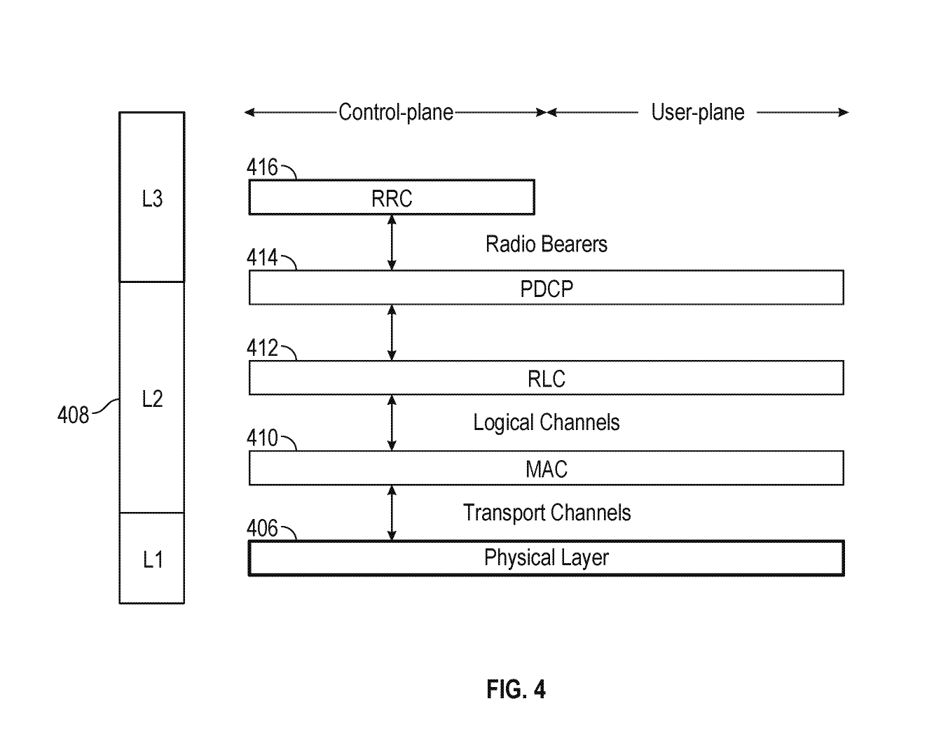

FIG. 4 is a diagram illustrating an example of a radio protocol architecture for a user plane and a control plane. The radio protocol architecture may take on various forms depending on the particular application. An example for an LTE system will now be presented with reference to FIG. 4. Turning to FIG. 4, the radio protocol architecture for the UE and the eNB is shown with three layers: Layer 1 (L1 layer), Layer 2 (L2 layer), and Layer 3 (L3 layer). Layer 1 is the lowest layer and implements various physical layer signal processing functions. Layer 1 will be referred to herein as the physical layer 406. Layer 2 (L2 layer) 408 is above the physical layer 406 and is responsible for the link between the UE and eNB over the physical layer 406.

In the user plane, the L2 layer 408 is shown to include a media access control (MAC) sublayer 410, a radio link control (RLC) sublayer 412, and a packet data convergence protocol (PDCP) 414 sublayer, which are terminated at the eNB on the network side. Although not shown, the UE may have several upper layers above the L2 layer 408 including a network layer (e.g., IP layer) that is terminated at the PDN gateway 218 (see FIG. 2) on the network side, and an application layer that is terminated at the other end of the connection (e.g., far end UE, server, etc.).

The PDCP sublayer 414 may provide multiplexing between different radio bearers and logical channels. The PDCP sublayer 414 may also provide header compression for upper layer data packets to reduce radio transmission overhead, security by ciphering the data packets, and handover support for UEs between eNBs. The RLC sublayer 412 may provide segmentation and reassembly of upper layer data packets, retransmission of lost data packets, and reordering of data packets to compensate for out-of-order reception due to hybrid automatic repeat request (HARQ). The MAC sublayer 410 may provide multiplexing between logical and transport channels. The MAC sublayer 410 may also be responsible for allocating the various radio resources (e.g., resource blocks) in one cell among the UEs. The MAC sublayer 410 may also be responsible for HARQ operations.

In the control plane, the radio protocol architecture for the UE and eNB is substantially the same for the physical layer 406 and the L2 layer 408 with the exception that there is no header compression function for the control plane. The control plane also may include a radio resource control (RRC) sublayer 416 in Layer 3. The RRC sublayer 416 may be responsible for obtaining radio resources (i.e., radio bearers) and for configuring the lower layers using RRC signaling between the eNB and the UE.

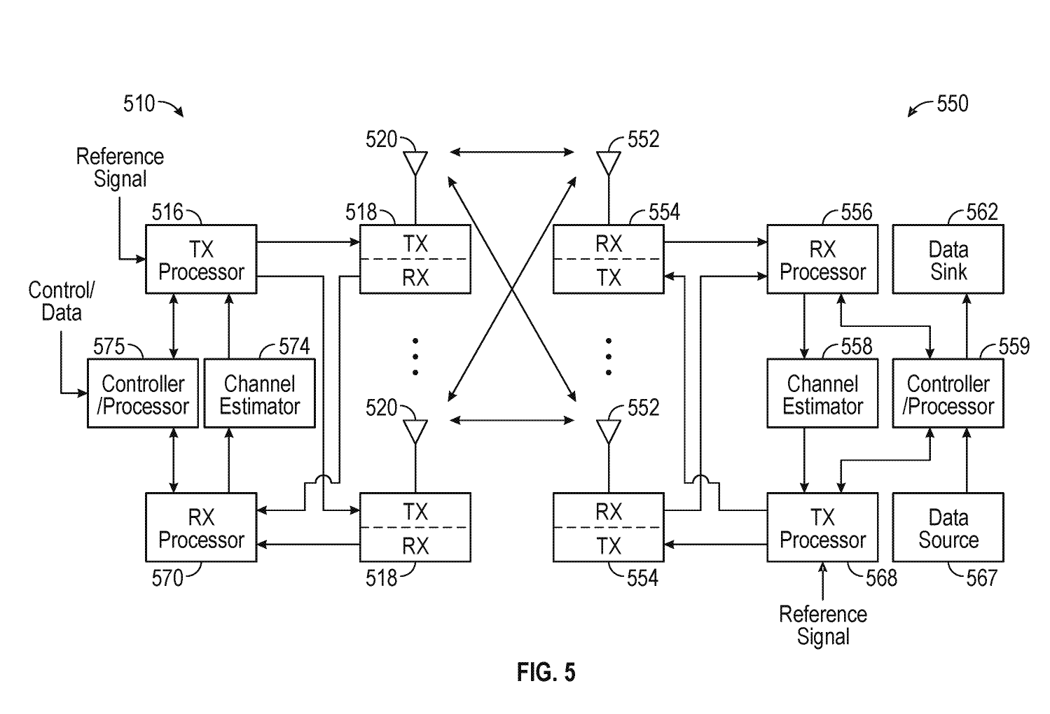

FIG. 5 is a diagram illustrating an example of a base station and user equipment (UE) in an access network. For the example of FIG. 5, the base station is illustrated as an evolved Node B (eNB). As illustrated in FIG. 5, the eNB 510 is in communication with the UE 550 in the access network. In the downlink (DL), upper layer packets from the core network are provided to a controller/processor 575. The controller/processor 575 may implement the functionality of the L2 layer described earlier in connection with FIG. 4. In the DL, the controller/processor 575 may provide header compression, ciphering, packet segmentation and reordering, multiplexing between logical and transport channels, and radio resource allocations to the UE 550 based on various priority metrics. The controller/processor 575 may also be responsible for HARQ operations, retransmission of lost packets, and signaling to the UE 550.

The TX processor 516 may implement various signal processing functions for the L1 layer (i.e., physical layer). The signal processing functions may include coding and interleaving to facilitate forward error correction (FEC) at the UE 550 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream may be spatially precoded to produce multiple spatial streams. Channel estimates from a channel estimator 574 may be used to determine the coding and modulation scheme, as well as for spatial processing. The channel estimate may be derived from a reference signal and/or channel condition feedback transmitted by the UE 550. Each spatial stream is then provided to a different antenna 520 via a separate transmitter 518 TX. Each transmitter 518 TX modulates an RF carrier with a respective spatial stream for transmission. Component 518 may be a transceiver with both a receiver and a transmitter function.

At the UE 550, each receiver 554 RX may receive a signal through its respective antenna 552. Component 554 may be a transceiver with both a receiver and a transmitter function. Each receiver 554 RX may recover information modulated onto an RF carrier and may provide the information to the receiver (RX) processor 556. The RX processor 556 may implement various signal processing functions of the L1 layer. The RX processor 556 may perform spatial processing on the information to recover any spatial streams destined for the UE 550. If multiple spatial streams are destined for the UE 550, they may be combined by the RX processor 556 into a single OFDM symbol stream. The RX processor 556 may convert the OFDM symbol stream from the time-domain to the frequency domain using a Fast Fourier Transform (FFT). The frequency domain signal may comprise a separate OFDM symbol stream for each subcarrier of the OFDM signal. The symbols on each subcarrier, and the reference signal, may be recovered and demodulated by determining the most likely signal constellation points transmitted by the eNB 510. These soft decisions may be based on channel estimates computed by the channel estimator 558. The soft decisions may be decoded and deinterleaved to recover the data and control signals that were originally transmitted by the eNB 510 on the physical channel. The data and control signals may then be provided to the controller/processor 559.

The controller/processor 559 may implement the L2 layer described earlier in connection with FIG. 4. In the uplink (UL), the controller/processor 559 may provide demultiplexing between transport and logical channels, packet reassembly, deciphering, header decompression, control signal processing to recover upper layer packets from the core network. The upper layer packets may then be provided to a data sink 562, which may represents the protocol layers above the L2 layer. Various control signals may also be provided to the data sink 562 for L3 layer processing. The controller/processor 559 may also be responsible for error detection using an acknowledgement (ACK) and/or negative acknowledgement (NACK) protocol to support HARQ operations.

In the UL, a data source 567 may be used to provide upper layer packets to the controller/processor 559. The data source 567 may represent the protocol layers above the L2 layer (L2). Similar to the functionality described in connection with the DL transmission by the eNB 510, the controller/processor 559 may implement the L2 layer for the user plane and the control plane by providing header compression, ciphering, packet segmentation and reordering, and multiplexing between logical and transport channels based on radio resource allocations by the eNB 510. The controller/processor 559 may also be responsible for HARQ operations, retransmission of lost packets, and signaling to the eNB 510.

Channel estimates derived by a channel estimator 558 from a reference signal or feedback transmitted by the eNB 510 may be used by the TX processor 568 to select the appropriate coding and modulation schemes, and to facilitate spatial processing. The spatial streams generated by the TX processor 568 may be provided to different antenna 552 via separate transmitters 554 TX. Each transmitter 554 TX may modulate an RF carrier with a respective spatial stream for transmission.

The UL transmission may be processed at the eNB 510 in a manner similar to that described in connection with the receiver function at the UE 550. Each receiver 518 RX may receive a signal through its respective antenna 520. Each receiver 518 RX may recover information modulated onto an RF carrier and may provide the information to a RX processor 570. The RX processor 570 may implement the L1 layer.

The controller/processor 559 may implement the L2 layer described earlier in connection with FIG. 4. In the UL, the controller/processor 559 may provide demultiplexing between transport and logical channels, packet reassembly, deciphering, header decompression, control signal processing to recover upper layer packets from the UE 550. Upper layer packets from the controller/processor 575 may be provided to the core network. The controller/processor 559 may also be responsible for error detection using an ACK and/or NACK protocol to support HARQ operations.

For 3GPP wireless systems, a congestion control protocol, Application-specific Congestion control for Data Communication (ACDC), may be implemented in connected mode to allow a network operator to prioritize or restrict attempts to send data from specific applications, to mitigate access network or core network overload. For example, ACDC may be optional at both the network side and the UE side and may be applicable to UTRAN, E-UTRAN and other radio access networks (RANs). In some examples, ACDC may not be applicable to high priority UEs which are members of, for example, Access Classes 11-15.

In various aspects, ACDC may include the following steps described herein. In various examples, a home network may configure the UE with ACDC categories (e.g., at least 4 ACDC categories), ranked in, for example, decreasing order of probability of being restricted (e.g., ACDC category 1 having the lowest probability of being restricted) and with a list of operator-identified applications in each of these ACDC categories. In other aspects, the ACDC categories may be ranked in, for example, increasing order of probability of being restricted.

In various examples, the home network may broadcast access control parameters (e.g., barring rate, barring time, barring probability, time of day, geographic location or geolocation, etc.) for each ACDC category and may also broadcast an indication of whether ACDC applies to roaming UEs.

In various examples, when an application at the UE triggers a request to send data, the UE may check the ACDC category to which this application belongs, then apply congestion control per the access control parameters broadcast by the network for the corresponding ACDC category. If the application does not belong to any ACDC category, for example, the UE may consider the application as being part of the lowest-ranked ACDC category (i.e., the ACDC category that is the highest probability of being restricted).

In Rel-13, ACDC is specified to be applicable only when the UE is in idle mode, i.e., when the UE does not have a signaling connection established with an access network. Thus, when applicable only in the idle mode, when the UE has switched to connected mode (e.g. after call origination) ACDC no longer applies and all applications may send data independent of their ACDC category.

In various aspects, an application is a service which performs some tasks for a user. Example applications may include a Web browser, a search engine, e-mail, file transfer program, an emergency services Web page, a geographic map, etc. ACDC may be used to prioritize UE access attempts according to specific applications to mitigate network overload by applying a particular priority scheme to each application. By extending the usage of ACDC in the connected mode, a user is prevented from subverting the priority scheme by using a higher priority (but undesired) application in idle mode simply to gain network access and after gaining access, switching to a lower priority (but desired) application in connected mode, where ACDC does not apply.

Example techniques for extending the ACDC protocol to connected mode are disclosed herein. In various examples, in connected mode, multiple triggers for the usage of ACDC may be considered (e.g., application start, first time an application starts sending data, request to send data after a certain time period of inactivity, etc.), and multiple ways to use the access control parameters may also be considered (e.g., prevention of sending data done at the application layer, by the modem, or by the high level operating system (HLOS)).

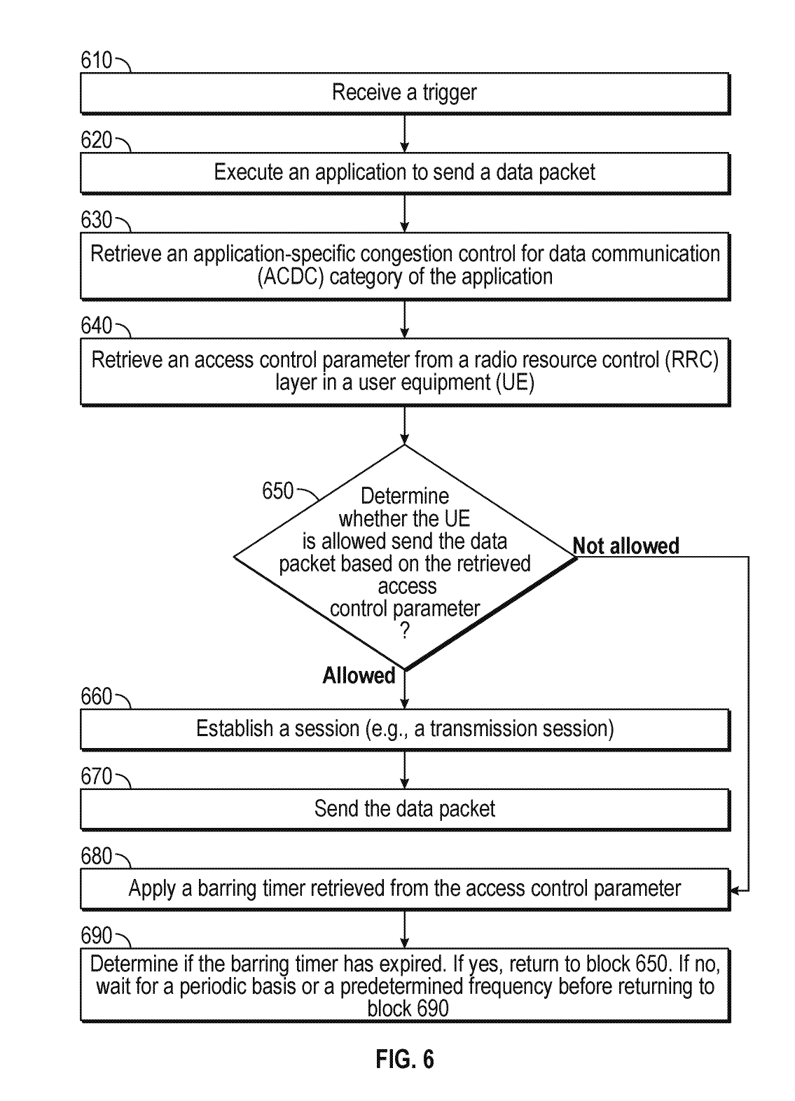

FIG. 6 is a flow chart illustrating a first example for congestion control in a user equipment (UE), in accordance with aspects of the present disclosure. In various aspects, ACDC in connected mode may be executed by an application residing in an UE. In various examples, the application (Appl) is software or firmware embedded within an UE. For example, an application which operates at the application layer may execute ACDC in connected mode using a processor (e.g., processor 104 in FIG. 1, controller processor 559, RX processor 556 or TX processor 568 in FIG. 5) with the following steps disclosed herein.

In block 610, the UE receives a trigger. For example, the trigger may be internally generated within the UE or the trigger may be from an external source and received by the antenna 552 and receiver 554. In block 620, the UE executes an application to send a data packet. For example, upon receipt of a trigger, a UE, e.g., using an application in the application layer, executes sending a data packet. A trigger is a defined event which initiates a series of sequential steps. Example triggers may include, but are not limited to, a session initiation request from an application, a request to send a data packet (i.e., perform a data packet transmission), an initial request from an application to send a data packet (i.e., perform a data packet transmission), a request from an application to send a burst of data packets after an inactivity period. In various examples, an inactivity period is a predetermined period of time when there has been no data packet transmission by the application.

In block 630, the UE retrieves an Application-specific Congestion control for Data Communication (ACDC) category of the application. For example, the retrieving may be performed by the application which retrieves its ACDC category. In one example, the mapping between ACDC categories and applications may be provisioned by a home operator (e.g., network service provider) to the UE using device management, for example, open mobile alliance-device management (OMA-DM). In various examples, the mapping between the ACDC categories and applications may be stored in a modem or in the application layer of the UE.

In block 640, the UE retrieves an access control parameter from a radio resource control (RRC) layer in the UE. In various examples, the RRC layer resides in the modem of the UE. The access control parameter is associated with the retrieved ACDC category. In some examples, the access control parameter is broadcast by the eNB 510 to the UE and stored in the RRC layer upon receipt. The RRC layer may include a processor and an associated memory for storage of data. In various examples, the application executes the retrieval in block 640. Access control parameters may, for example, include barring rate, barring time, barring probability, time of day, geographic location or geolocation, etc.

In block 650, the UE determines whether it is allowed send the data packet based on the retrieved access control parameter. And if allowed to send the data packet, in block 660, the UE establishes a session (e.g., a transmission session) and sends the data packet in block 670. For example, the antenna 552 working in conjunction with the transceiver 554 may be used to send the data packet. Or if not allowed to send the data packet, in block 680, the UE applies a barring timer retrieved from the access control parameter, and in block 690 determines if the barring timer has expired. If yes, return to block 650. If no, wait for a periodic basis or a predetermined frequency before returning to block 690. For example, the application in the UE may check, based on the access control parameters, if it is allowed or not to send the data packet using the retrieved access control parameters. If the application is allowed to send data, it proceeds with session establishment and then sends data packet(s). If the application is not allowed to send data packet(s), it applies a barring timer retrieved from the access control parameters for this ACDC category. Then, when the barring timer expires, the application again checks if it is allowed to send data packet(s) using the retrieved access control parameters. In various examples, the application may check if it is allowed to send data packets on a periodic basis or according to a predetermined frequency.

The application as described in connection with FIGS. 6-11 may be software or firmware associated with one or more of the following for execution: processor 104 in FIG. 1, controller/processor 559, RX processor 556 or TX processor 568 in FIG. 5, and associated with one or more of the following for storage of data: memory 105 in FIG. 1 and a memory component embedded in one of the controller/processor 559, RX processor 556 or TX processor 568 in FIG. 5.

In various examples, execution of ACDC in connected mode by an application layer may include incentive(s) to enforce ACDC on themselves to avoid attempting to gain the highest priority by obtaining, for example, the highest ranking ACDC category to get the best service for itself. In various examples, enhancements of the application may be added to support the ACDC in connected mode feature.

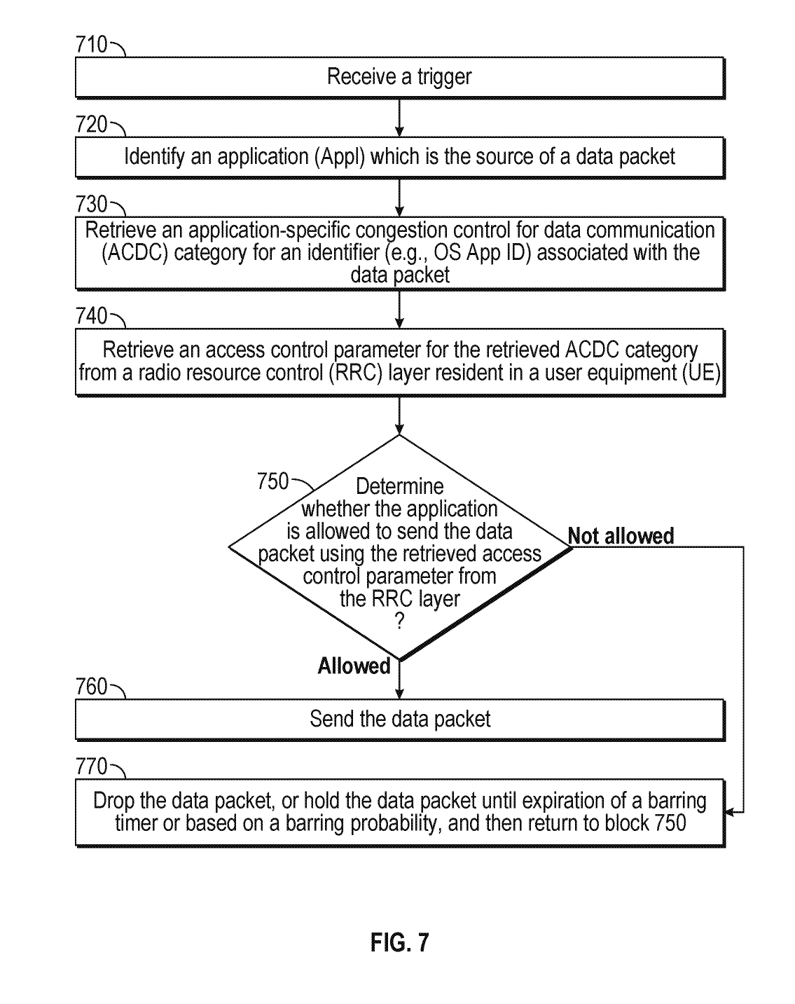

FIG. 7 is a flow chart illustrating a second example for congestion control of a user equipment (UE), in accordance with aspects of the present disclosure. In various aspects, ACDC in connected mode may be executed by a modem resident within a UE. In various examples, the modem includes a modulator which resides within TX processor 568 and a demodulator which resides within RX processor 556.

In block 710, the UE receives a trigger. For example, the trigger may be internally generated within the UE or the trigger may be from an external source and received by the antenna 552 and receiver 554. In block 720, the modem within the UE identifies an application (Appl) which is the source of a data packet. For example, the association between the data packet and the application may be identified by having the high level operating system (HLOS) pass an identifier, e.g., operating system (OS) App ID, of the application along with the data packet. For example, each data packet may be tagged with the identifier, e.g., OS App ID. That is, the data packet may be transformed from the HLOS to the modem along with an identifier (i.e., a tag) as an auxiliary data field which associates the data packet with the application.

In block 730, the modem retrieves an Application-specific Congestion control for Data Communication (ACDC) category for an identifier (e.g., OS App ID) associated with the data packet passed from the HLOS. For example, the mapping between ACDC categories and applications may be provisioned by the home operator (e.g., network service provider) to the UE using open mobile alliance-device management (OMA-DM) and may be stored in the modem or at the application layer. In various examples, the ACDC categories may be pre-configured at the UE. That is, the mapping between ACDC categories and applications may be performed a priori (e.g., prior to transition to connected mode).

In block 740, the modem retrieves an access control parameter for the retrieved ACDC category from a radio resource control (RRC) layer resident in the UE. In various examples, the RRC layer resides in the modem of the UE. In block 750, the modem determines whether the application is allowed to send the data packet using the retrieved access control parameter from the RRC layer. That is, the modem (which resides in the UE) determine whether a data packet may be sent by using the retrieved access control parameter. If the application is allowed to send the data packet, then in block 760, the application sends the data packet (i.e. the application proceeds with the data packet transmission). If the application is not allowed to send the data packet, then in block 770, the modem drops the data packet. In various examples, the modem may instead hold the data packet and try to send the data packet at a later time. For example, the data packet is held (i.e., data packet transmission is held) until expiration of a barring timer or based on a barring probability. In some examples, the modem will perform a recheck by returning to block 750.

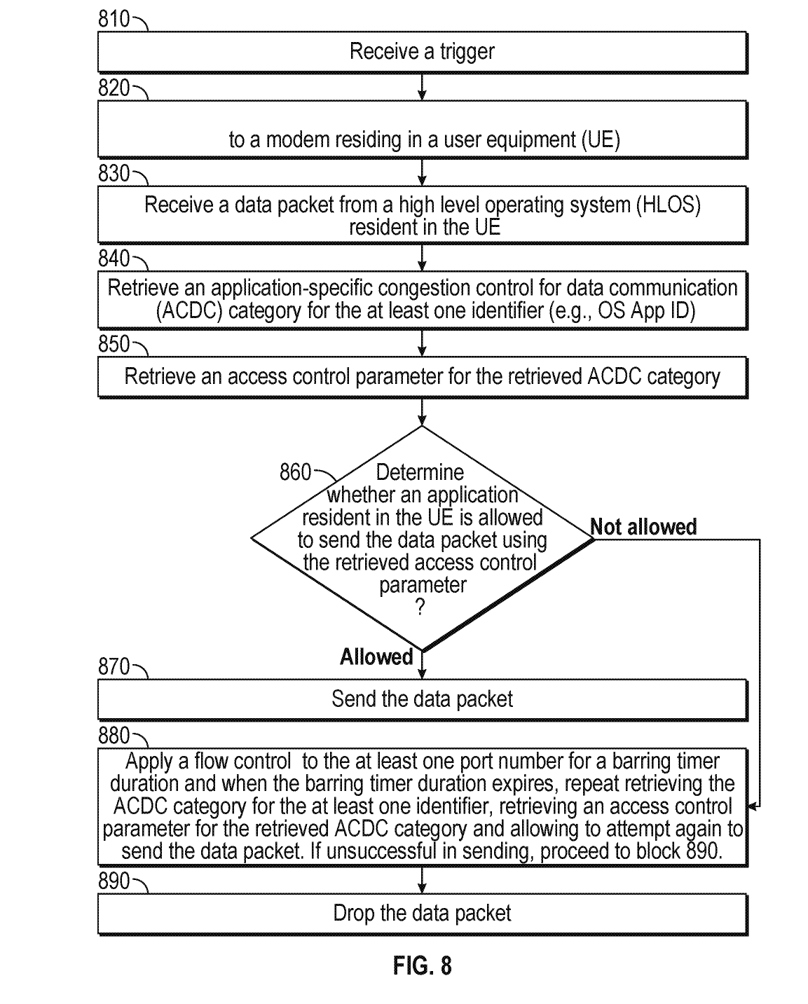

FIG. 8 is a flow chart illustrating a third example for congestion control of a user equipment (UE), in accordance with aspects of the present disclosure. In various aspects, ACDC in connected mode may be executed by a modem resident within a UE. In block 810, the UE receives a trigger. For example, the trigger may be internally generated within the UE or the trigger may be from an external source and received by the antenna 552 and receiver 554.

In block 820, a high level operating system (HLOS) residing within the UE opens a port and provides at least one port number and at least one identifier to the modem residing in the UE. In various examples, the HLOS is software that runs on and resides within one of the following: processor 104 in FIG. 1, controller/processor 559, RX processor 556 or TX processor 568 in FIG. 5.

That is, in various examples, upon receipt of a trigger, the first time an application opens a socket (e.g., software interface) at the HLOS for sending a data packet, the HLOS may open a port for that application and provide a port number and identifier (e.g., App OS ID) to the modem. In some examples, there may be multiple sockets opened and multiple associated port numbers per application (and hence, also multiple identifiers associated with the multiple associated port numbers). In various examples, the modem maintains a mapping of port numbers with identifiers (e.g. App OS IDs). In various examples, an IP address may be associated with an identifier (e.g. App OS IDs). In various examples, the mapping is maintain in a memory within the modem or in a hardware register associated with the modem.

In block 830, the modem receives a data packet from a high level operating system (HLOS) resident in the UE. In the event there are multiple sockets opened and multiple associated port numbers if any of the port numbers has not been processed before by the modem, the modem filters the data packet based on that port number and looks up an associated identifier (e.g. OS App ID) for that port number, for example, from a table or a database.

In block 840, the modem retrieves an Application-specific Congestion control for Data Communication (ACDC) category for the at least one identifier (e.g., OS App ID) passed from the HLOS. For example, the mapping between ACDC categories and identifiers may be provisioned by the home operator (e.g., network service provider) to the UE using an open mobile alliance-device management (OMA-DM) and may be stored in the modem (e.g., stored in a memory within the modem or in a hardware register associated with the modem) or at the application layer. In various examples, the ACDC categories may be pre-configured at the UE. That is, the mapping between ACDC categories and identifiers may be performed a priori (e.g., prior to transition to connected mode).

In block 850, the modem retrieves an access control parameter for the retrieved ACDC category from the RRC layer. In various examples, the RRC layer resides in the modem of the UE. In block 860, the modem determines whether the application (resident in the UE) is allowed to send the data packet using the retrieved access control parameter. If the application is allowed to send the data packet, in block 870, the application sends the data packet (i.e., the application proceeds with data packet transmission).

In some examples, the application is allowed to send subsequent data packets following the determining step in block 860. In these examples, the associated ports for the subsequent data packets are considered processed and there is no need for filtering to be performed on the associated ports for the subsequent data packets. That is, the ACDC check is performed only the first time the application attempts to send the initial data packet.

In some examples, the modem may periodically retrieve one or more access control parameters for the retrieved ACDC category associated with the identifier to determine if the retrieved ACDC category has changed. If the retrieved ACDC category has changed, the application performs the ACDC check again.

In block 880, if the application is not allowed to send the data packet, the modem applies a flow control to the at least one port number for a barring timer duration. For example, the flow control may be based on a TCP congestion control/backoff procedure which may scale window sizes and/or retransmit timers due to TCP timeouts. While the barring timer is running, the modem may suppress the Transmission Control Protocol (TCP) congestion control/backoff procedure since the data packet and ACK messages may not be transmitted over the air (OTA). In some examples, when the barring timer expires, the modem may repeat retrieving the ACDC category for the identifier (e.g. OS App ID) passed from the HLOS, retrieving an access control parameter for the retrieved ACDC category and allowing the application to attempt again to send the data packet. In various examples, the application may check if it is allowed to send data packets on a periodic basis or according to a predetermined frequency. Alternatively, if unsuccessful in sending the data packet, in block 890, the modem may drop the data packet if the application is not allowed to send the data packet.

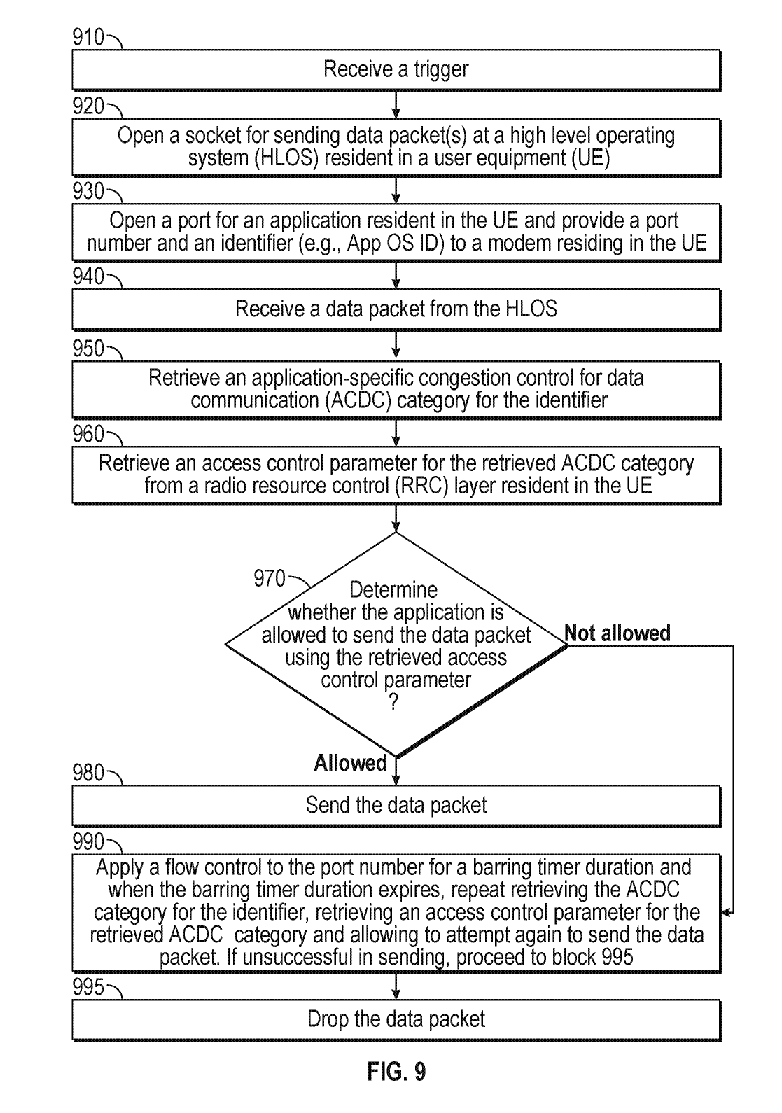

FIG. 9 is a flow chart illustrating a fourth example for congestion control of a user equipment (UE), in accordance with aspects of the present disclosure. In various aspects, ACDC in connected mode may be executed by a modem resident within a UE. In block 910, the UE receives a trigger. For example, the trigger may be internally generated within the UE or the trigger may be from an external source and received by the antenna 552 and receiver 554.

Upon receipt of the trigger, in block 920, an application residing in the UE opens a socket (e.g., software interface) for sending data packet(s) at a high level operating system (HLOS) residing in the UE. In block 930, the HLOS opens a port for the application resident in the UE and provides a port number and an identifier (e.g., App OS ID) to a modem residing in the UE. In various examples, the modem includes a modulator which resides within TX processor 568 and a demodulator which resides within RX processor 556. In some examples, there may be multiple sockets opened and multiple associated port numbers per application. The modem may maintain a mapping of port numbers with identifiers (e.g. App OS IDs). In various examples, an IP address may be associated with identifier(s) (e.g. App OS ID(s)).

In block 940, a modem that resides in the UE receives a data packet from the HLOS. In the event there are multiple sockets opened and multiple associated port numbers if any of the port numbers has not been processed before by the modem, the modem filters the data packet based on that port number and looks up an associated identifier (e.g. OS App ID) for that port number, for example, from a table or a database.

In block 950, the modem retrieves an Application-specific Congestion control for Data Communication (ACDC) category for the identifier (e.g. OS App ID) passed from the HLOS. For example, the mapping between ACDC categories and identifiers may be provisioned by the home operator (e.g., network service provider) to the UE using an open mobile alliance-device management (OMA-DM) and may be stored in the modem (e.g., stored in a memory within the modem or in a hardware register associated with the modem) or at the application layer. In various examples, the ACDC categories may be pre-configured at the UE. That is, the mapping between ACDC categories and identifiers may be performed a priori (e.g., prior to transition to connected mode).

In block 960, the modem retrieves an access control parameter for the retrieved ACDC category from the RRC layer resident in the UE. In block 970, the modem determines whether the application is allowed to send the data packet using the retrieved access control parameter. In block 980, if it is determined that the application is allowed to send the data packet, the application sends the data packet (i.e., it proceeds with data packet transmission).

In block 990, if the application is not allowed to send the data packet, the modem applies a flow control to the port number for the barring timer duration. For example, the flow control may be based on a TCP congestion control/backoff procedure which may scale window sizes and/or retransmit timers due to TCP timeouts. While the barring timer is running, the modem may suppress the Transmission Control Protocol (TCP) congestion control/backoff procedure since the data packet and ACK messages may not be transmitted over the air (OTA). For example, the TCP congestion control/backoff procedures may scale window sizes and/or retransmit timers due to TCP timeouts. In some examples, when the barring timer expires, the modem may repeat retrieving the ACDC category for the identifier (e.g. OS App ID) passed from the HLOS, retrieving an access control parameter for the retrieved ACDC category and allowing the application to attempt again to send the data packet. In various examples, the application may check if it is allowed to send data packets on a periodic basis or according to a predetermined frequency. Alternatively, if unsuccessful in sending the data packet, in block 995, the modem drops the data packet if the application is not allowed to send the data packet.

In various examples, the modem may be augmented by data buffers for each ACDC category. By including data buffers, the modem prevents or minimizes dropping of data packets sent by an application that are barred by ACDC. For example data packets sent by an application which is barred may be stored in the data buffers. In some examples, periodically (e.g., based on the barring times per ACDC category), the modem may scan the data buffers and if any a data buffer is non-empty, the modem may try to send the data packet at the head of the data buffer again applying the ACDC probabilities and other access control parameters. In some examples, the usage of data buffers in the modem may provide increased flexibility in data packet flow management since the modem may be aware of real-time data packet flow status.

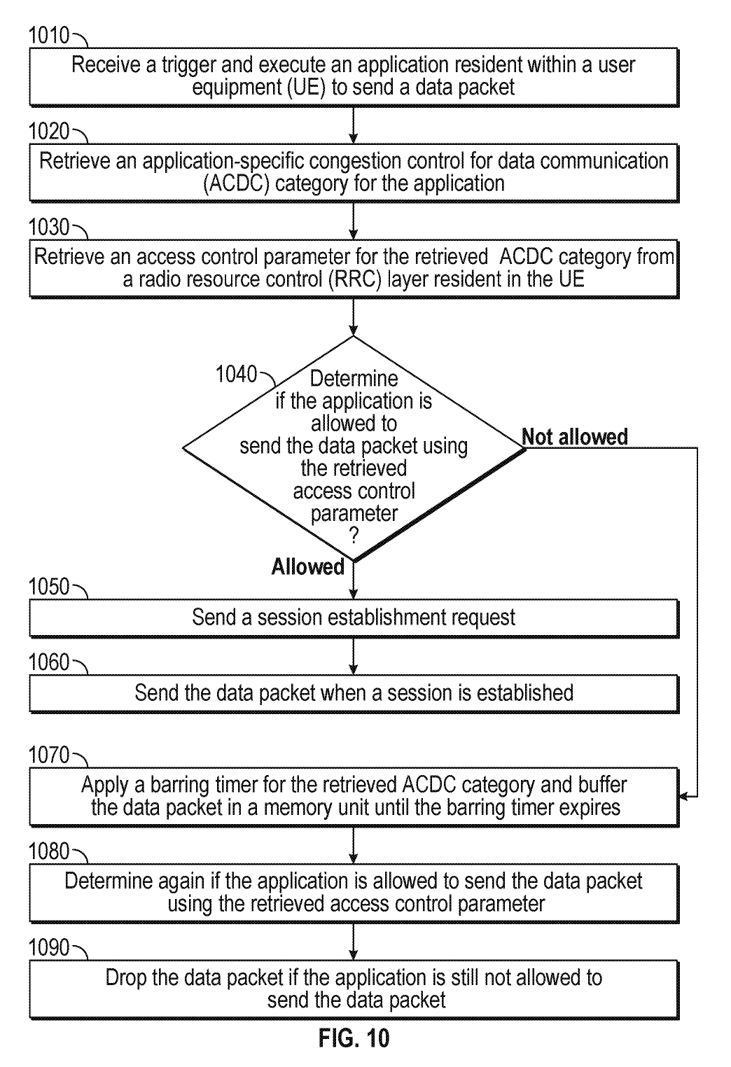

FIG. 10 is a flow chart illustrating a fifth example for congestion control in a user equipment (UE), in accordance with aspects of the present disclosure. In various aspects, ACDC in connected mode may be executed by a high level operating system (HLOS) residing in the UE. In various examples, the HLOS is software embedded in the UE. And, in various examples, the HLOS may use one or more of the following for execution: processor 104 in FIG. 1, controller/processor 559, RX processor 556 or TX processor 568 in FIG. 5.

In block 1010, the UE receives a trigger and executes an application (Appl) resident within the UE to send a data packet. In block 1020, the HLOS retrieves an Application-specific Congestion control for Data Communication (ACDC) category for the application. For example, the mapping between ACDC categories and applications may be provisioned by the home operator (e.g., network service provider) to the UE using OMA-DM and may be stored in the modem or at the application layer. In block 1030, the HLOS retrieves an access control parameter for the retrieved ACDC category from a radio resource control (RRC) layer resident in the UE. In various examples, the RRC layer resides in the modem of the UE.

In block 1040, the HLOS determines if the application is allowed to send the data packet using the retrieved access control parameter. In block 1050, if the application is allowed to send the data packet, the application proceeds with sending a session establishment request to the modem. And, in block 1060, the application sends the data packet when a session is established.

In block 1070, if the application is not allowed to send the data packet, the application applies a barring timer (retrieved from the RRC layer) for the retrieved ACDC category and buffers the data packet in a memory unit until the barring timer expires. Upon expiration of the barring timer, in block 1080, the HLOS may determine again if the application is allowed to send the data packet using the retrieved access control parameter. In various examples, the HLOS may check if the application is allowed to send data packets on a periodic basis or according to a predetermined frequency. For example, the application may also disable a socket from sending data packet(s) until the barring timer expires so that there is no need to buffer data. That is, while the socket is disabled, the socket is unwriteable. The application may not be able to send further data packet(s) until the socket is enabled, that is, until the socket is made writeable again. Alternatively, in block 1090, the HLOS or the application drops the data packet if the application is still not allowed to send the data packet.

In various examples, having ACDC performed by the HLOS does not require any new application program interfaces (APIs), for example, for passing an identifier (e.g. OS App ID) or port number to the modem. Also, data loss (e.g. dropped data packets) may be avoided while an application is barred from sending data packet(s).

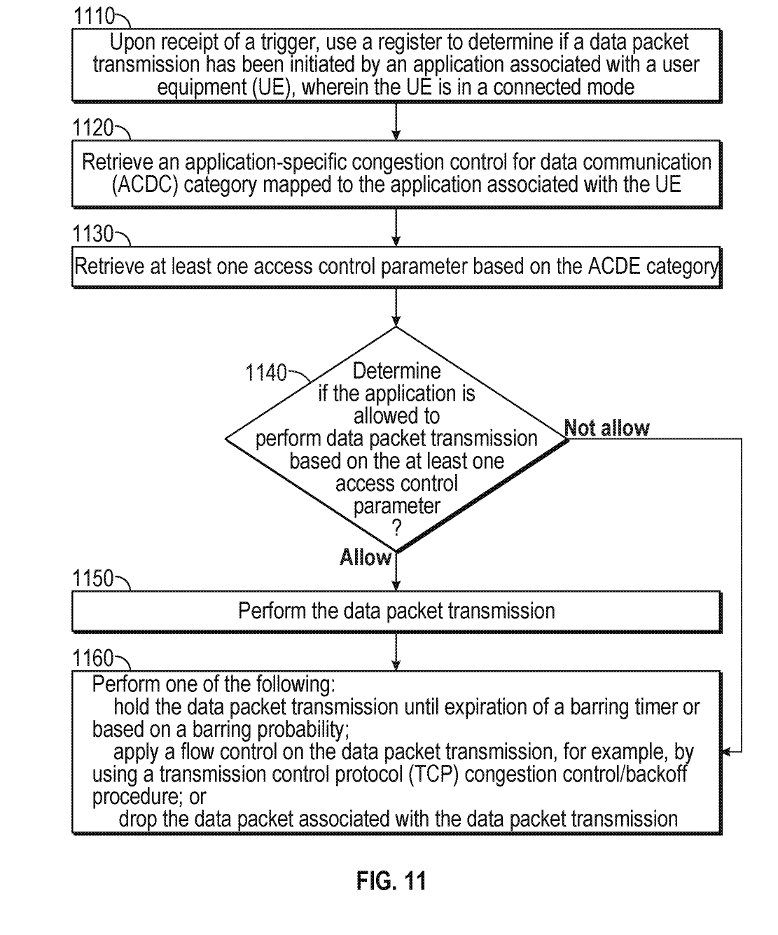

FIG. 11 is a flow chart illustrating a sixth example for congestion control in a user equipment (UE). In block 1110, upon receipt of a trigger, an entity using a register to determine if a data packet transmission has been initiated by an application associated with a user equipment (UE), wherein the UE is in a connected mode. That is, the entity determines, upon receipt of a trigger, if an application associated with the UE is attempting to perform a data packet transmission, wherein the UE is in a connected mode. In various examples, the trigger is one of the following: a session initiation request from an application, a request to send a data packet (i.e., perform a data packet transmission), an initial request from an application to send a data packet (i.e., perform a data packet transmission), or a request from an application to send a burst of data packets after an inactivity period. In various examples, the inactivity period is a predetermined period of time when there has been no data packet transmission. In some examples, the entity may be the controller/processor 559 illustrated in FIG. 5. In other examples, the entity may be the TX processor 568 illustrated in FIG. 5.

In block 1120, an entity retrieves an Application-specific Congestion control for Data Communication (ACDC) category mapped to the application associated with the UE. In various examples, the mapping between the ACDC category and the application is performed a priori to a transition to the connected mode. In various example, the ACDC category (e.g., at least 4 ACDC categories), may be ranked in decreasing order of probability of being restricted. That is, ACDC category 1 has the lowest probability of being restricted. There may be a list of operator-identified applications in each of these ACDC categories. In other examples, the ACDC category may be ranked in increasing order of probability of being restricted. The ranking of being in decreasing order or in increasing order may be a user choice or a design choice. In various examples, the ACDC category, which is a mapping to the application may be provisioned by a home operator to the user using device management, for example, open mobile alliance-device management (OMA-DM) and may be stored, for example, in a modem or in an application layer of the UE. In some examples, the entity may be the controller/processor 559 illustrated in FIG. 5. In other examples, the entity may be the TX processor 568 illustrated in FIG. 5.

In block 1130, an entity retrieves at least one access control parameter based on the ACDC category. In various examples, the at least one access control parameter may include at least one of barring rate, barring time, barring probability, time of day, geographic location or geolocation of the UE. In various examples, the at least one access control parameter is broadcast by a network for the retrieved ACDC category from a radio resource control (RRC) layer of the UE. In various examples, the UE is connected to the network. In some examples, the entity may be the controller/processor 559 illustrated in FIG. 5. In other examples, the entity may be the TX processor 568 illustrated in FIG. 5.

In block 1140, an entity determines if the application is allowed to perform data packet transmission based on the at least one access control parameter. In various examples, the entity in block 1140 may be the TX processor 568 illustrated in FIG. 5. If allowed, proceed to block 1150. If not allowed, proceed to block 1160. Performing data packet transmission may include sending one or more data packets. In various examples, the association between a data packet and the application may be identified by passing an identifier, e.g., operating system (OS) App ID, of the application along with the data packet. In various examples, a high level operating system (HLOS) passes the identifier of the application along with the data packet. For example, each data packet may be tagged with the identifier, e.g., OS App ID. In various examples, the ACDC category is retrieved based on the identifier. In various examples, the identifier may be mapped to a port number and/or a socket.

In various examples, the identifier is an auxiliary data field which associates the data packet with the application. For example, an identifier may be based on a combination of a source IP address or a source port and a destination IP address or a destination port associated with the application. A data packet flow from the application may be filtered based on a mapping between an ACDC category and a combination of the source IP address or the source port and the destination IP address or the destination port. That is, maintain a mapping between the ACDC category and a combination of a source IP address or a source port and a destination IP address or a destination port. A mapping between the OS App ID and a combination of source IP address or the source port and the destination IP address or the destination port may be maintained. That is, maintain a mapping between the OS App ID and a combination of a source IP address or a source port and a destination IP address or a destination port.

In block 1150, an entity performs the data packet transmission. In some examples, data packet transmission may be performed by the TX processor 568 illustrated in FIG. 5. In other examples, data packet transmission may be performed by the transmitter 554 illustrated in FIG. 5. In yet other examples, data packet transmission may be performed by the TX processor 568 working in conjunction with the transmitter 554 illustrated in FIG. 5. The data packet transmission may be performed on a periodic basis or according to a predetermined frequency.

In block 1160, an entity performs one of the following:
hold the data packet transmission until expiration of a barring timer or based on a barring probability.
apply a flow control on the data packet transmission, for example, by using a transmission control protocol (TCP) congestion control/backoff procedure.
drop the data packet associated with the data packet transmission.

In some examples, the entity in block 1160 may be the TX processor 568 illustrated in FIG. 5. In other examples, the entity may be the controller/processor 559 illustrated in FIG. 5. In various examples, the memory 105 illustrated in FIG. 1 is configured to hold the data packet prior to transmission. In various examples, if performing data packet transmission is not allowed, flow control may be applied to an associated port number for a barring timer duration. While the barring timer duration is running, the entity may suppress transmission control protocol (TCP) congestion control/backoff procedure. For example, when the barring timer expires the modem may again retrieve ACDC category for the identifier (e.g. OS App ID) passed from the HLOS.

In various aspects, the TX processor 568 (a.k.a., transmitter processor) may be configured to determine if the application is allowed to perform data packet transmission based on the at least one access control parameter. And, in various examples, a memory (e.g., memory 105 illustrated in FIG. 1) is coupled to the transmitter processor (e.g., the processor 104 illustrated in FIG. 1), the memory is configured to hold the data packet prior to data packet transmission. In various examples, the transmitter processor may be configured to hold the data packet transmission until expiration of a barring timer or based on a barring probability. And, in various examples, the transmitter processor may be configured to apply a flow control on the data packet transmission or to drop the data packet associated with the data packet transmission.

In various examples, the entity that performs the steps in one or more of blocks 1110 through 1160 may be an application layer, a modem and/or an HLOS. An application layer may include a processor (or processing circuit) coupled to a memory for performing one or more steps in blocks 1110 through 1160. A modem may include a transmitter, a receiver, a digital signal processor, a controller, a baseband processor, an antenna, an antenna control logic, a time reference, a frequency reference and/or a synchronizer, etc. An HLOS may include a processor (or a processing circuit) coupled to a memory for performing one or more steps in blocks 1110 through 1160.

In various examples, the method of flow diagrams in FIGS. 6, 7, 8, 9, 10 and 11 may be implemented by one or more of the exemplary network architecture and/or access network illustrated in FIGS. 1, 2 and/or 5. In various examples, the method of flow diagrams in FIGS. 6, 7, 8, 9, 10 and 11 may be implemented by any other suitable apparatus or means for carrying out the described functions.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

Within the present disclosure, the word “exemplary” or “example” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another, even if they do not directly physically touch each other.

One or more of the components, blocks, features and/or functions illustrated in the figures may be rearranged and/or combined into a single component, block, feature or function or embodied in several components, blocks, or functions. Additional elements, components, blocks, and/or functions may also be added without departing from novel features disclosed herein. The apparatus, devices, and/or components illustrated in the various drawings may be configured to perform one or more of the methods, features, or blocks described herein. The novel algorithms described herein may also be efficiently implemented in software and/or embedded in hardware.

It is to be understood that the specific order or hierarchy of blocks in the methods disclosed is an illustration of exemplary processes. Based upon design preferences, it is understood that the specific order or hierarchy of blocks in the methods may be rearranged. The accompanying method claims present elements of the various blocks in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited utilizing the phrase “means for” or, in the case of a method claim, the element is recited utilizing the phrase “step for.”

What is claimed is:

1. A method for congestion control in a user equipment (UE), comprising:
upon receipt of a trigger, using a register to determine if a data packet transmission has been initiated by an application associated with the UE, wherein the UE is in a connected mode;
retrieving an Application-specific Congestion control for Data Communication (ACDC) category mapped to the application associated with the UE, wherein the mapping of the ACDC category to the application is performed a priori to a transition to the connected mode;
retrieving at least one access control parameter based on the ACDC category; and
determining if the application is allowed to perform the data packet transmission based on the at least one access control parameter.

2. The method of claim 1, further comprising performing the data packet transmission on a periodic basis.

3. The method of claim 1, further comprising performing the data packet transmission according to a predetermined frequency.

4. The method of claim 1, further comprising performing one of the following:
holding the data packet transmission until expiration of a barring timer or based on a barring probability;
applying a flow control on the data packet transmission; or
dropping a data packet associated with the data packet transmission.

5. The method of claim 4, further comprising using a transmission control protocol (TCP) congestion control/backoff procedure for applying the flow control.

6. The method of claim 1, wherein the trigger is one of the following: a session initiation request from the application, a request to perform the data packet transmission, an initial request from the application to perform the data packet transmission or a request from the application to send a burst of data packets after an inactivity period.

7. The method of claim 1, wherein the at least one access control parameter is one of the following: a barring rate, a barring time, a barring probability, a time of day, or a geolocation of the UE.

8. The method of claim 1, wherein a data packet associated with the data packet transmission is associated with the application by an identifier of the application.

9. The method of claim 8, wherein the identifier is an auxiliary data field which associates the data packet with the application.

10. The method of claim 8, wherein the identifier is an operating system (OS) App ID of the application.

11. The method of claim 10, wherein the data packet is tagged with the identifier and the ACDC category is retrieved based on the identifier.

12. The method of claim 10, wherein the identifier is based on a combination of a source IP address or a source port and a destination IP address or a destination port associated with the application.

13. The method of claim 10, further comprising maintaining a mapping between the OS App ID and a combination of a source IP address or a source port and a destination IP address or a destination port.

14. The method of claim 10, further comprising maintaining a mapping between the ACDC category and a combination of a source IP address or a source port and a destination IP address or a destination port.

15. The method of claim 1, wherein the ACDC category is ranked in an order of probability of being restricted.

16. An apparatus for congestion control in a user equipment (UE), comprising:
a controller configured to perform the following:
a) determine, upon receipt of a trigger, if an application associated with the UE is attempting to perform a data packet transmission, wherein the UE is in a connected mode;
b) retrieve an Application-specific Congestion control for Data Communication (ACDC) category mapped to the application associated with the UE, wherein a mapping between the ACDC category and the application is performed a priori to a transition to the connected mode; and
c) retrieve at least one access control parameter based on the ACDC category; and
a transmitter processor coupled to the controller, the transmitter processor configured to determine if the application is allowed to perform the data packet transmission based on the at least one access control parameter; and
a transmitter coupled to the transmitter processor, the transmitter configured to transmit a data packet.

17. The apparatus of claim 16, wherein, the transmitter is configured to transmit the data packet on a periodic basis.

18. The apparatus of claim 16, wherein, the transmitter is configured to transmit the data packet according to a predetermined frequency.

19. The apparatus of claim 16, further comprising a memory coupled to the transmitter processor, the memory configured to hold the data packet prior to the data packet transmission; and wherein the transmitter processor is further configured to hold the data packet transmission until expiration of a barring timer or based on a barring probability.

20. The apparatus of claim 19, wherein the transmitter processor is further configured to apply a flow control on the data packet transmission or to drop the data packet associated with the data packet transmission.

21. The apparatus of claim 16, wherein the trigger is one of the following: a session initiation request from the application, a request to perform the data packet transmission, an initial request from the application to perform the data packet transmission or a request from the application to send a burst of data packets after an inactivity period.

22. The apparatus of claim 16, wherein the data packet is associated with the application by an identifier of the application.

23. The apparatus of claim 16, wherein the ACDC category is ranked in an order of probability of being restricted.

24. An apparatus for congestion control in a user equipment (UE), comprising:
means for determining, upon receipt of a trigger, if an application associated with the UE is attempting to perform a data packet transmission, wherein the UE is in a connected mode;
means for retrieving an Application-specific Congestion control for Data Communication (ACDC) category mapped to the application associated with the UE, wherein a mapping between the ACDC category and the application is performed a priori to a transition to the connected mode;
means for retrieving at least one access control parameter based on the ACDC category; and
means for determining if the application is allowed to perform the data packet transmission based on the at least one access control parameter.

25. The apparatus of claim 24, further comprising means for performing the data packet transmission on a periodic basis.

26. The apparatus of claim 24, further comprising means for performing the data packet transmission according to a predetermined frequency.

27. The apparatus of claim 24, further comprising:
means for holding the data packet transmission until expiration of a barring timer or based on a barring probability; and
means for applying a flow control on the data packet transmission or for dropping a data packet associated with the data packet transmission.

28. The apparatus of claim 24, wherein the trigger is one of the following: a session initiation request from the application, a request to perform the data packet transmission, an initial request from the application to perform the data packet transmission or a request from the application to send a burst of data packets after an inactivity period.

29. A non-transitory computer-readable medium storing computer executable code, the computer executable code comprising:
instructions for causing the at least one processor to determine, upon receipt of a trigger, if an application associated with the UE is attempting to perform a data packet transmission, wherein the UE is in a connected mode;
instructions for causing the at least one processor to retrieve an Application-specific Congestion control for Data Communication (ACDC) category mapped to the application associated with the UE, wherein a mapping between the ACDC category and the application is performed a priori to a transition to the connected mode;
instructions for causing the at least one processor to retrieve at least one access control parameter based on the ACDC category; and
instructions for causing the at least one processor to determine if the application is allowed to perform the data packet transmission based on the at least one access control parameter.

30. The non-transitory computer-readable medium of claim 29, wherein the computer executable code further comprising:
instructions for causing the at least one processor to hold the data packet transmission until expiration of a barring timer or based on a barring probability; and
instructions for causing the at least one processor to apply a flow control on the data packet transmission or to drop a data packet associated with the data packet transmission.
